(19) United States
(12) Patent Application Publication
(10) Pub. No.: US 2013/0225365 A1
(43) Pub. Date: Aug. 29, 2013

(54) DRIVE TRAIN HAVING A HYDRODYNAMIC RETARDER

(71) Applicants: Tilman Huth, Satteldorf (DE); Dieter Laukemann, Crailsheim (DE)

(72) Inventors: Tilman Huth, Satteldorf (DE); Dieter Laukemann, Crailsheim (DE)

(73) Assignee: VOITH PATENT GMBH, Heidenheim (DE)

(21) Appl. No.: 13/704,060

(22) PCT Filed: Nov. 15, 2011
(86) PCT No.: PCT/EP2011/005742

§ 371 Date: Dec. 18, 2012

(30) Foreign Application Priority Data
Nov. 19, 2010 (DE) 10 2010 051 715.1

(51) Int. Cl. F16H 47/06

(52) U.S. Cl. CPC F16H 47/06
USPC 477/59

(57) ABSTRACT

The invention concerns a drive train, in particular of a motor vehicle fitted with a drive motor, including a main output shaft; having a transmission connected downstream of the drive motor in the drive power flow, comprising a transmission input shaft and a transmission housing; the transmission input shaft is connected to and actuated by the main output shaft of the drive motor or can be switched into such connection by means of a coupling; having a hydrodynamic retarder, comprising a driven bladed primary wheel and a stationary bladed secondary wheel or which is driven in reverse direction of the primary wheel, whereas both wheels form together a frusto-conical work space which is filled or can be filled with working medium, for hydrodynamic transmission of torque from the primary wheel to the secondary wheel;
the drive motor includes an auxiliary output shaft, via which the primary wheel of the retarder is driven.

The invention is characterised in that the hydrodynamic retarder is connected to the auxiliary output shaft of the drive motor on the transmission side.

The present invention concerns a drive train having a hydrodynamic retarder, in particular a motor vehicle drive train, having the characteristics detailed in the preamble of the claim 1.

Hydrodynamic retarders have long been used as wear-free continuous brakes in motor vehicles or in stationary installations. Previously, there was a distinction between primary retarders, which operate as a function of the rotational speed of the drive motor, and secondary retarders, which are provided on the transmission output shaft or another auxiliary drive of the transmission and hence work as a function of the rotational speed of the transmission output shaft and consequently as a function of the travelling speed.

Primary retarders arranged on the primary side of the drive motor are described for instance in publications DE 44 08 349, DE 44 08 350, DE 44 40 162 and DE 199 39 726.

DE 44 46 288 describes a primary retarder on the primary side of the engine, and a second retarder, which is arranged as a secondary retarder on the transmission output side.

Document DE 198 40 284 A1 describes a primary retarder, which is arranged directly on the transmission input shaft.

Document DE 2 017 617 describes a hydrodynamic retarder arranged laterally on the transmission, whose rotor meshes via an intermediate gear wheel with a gear wheel of the transmission for instance the head gear wheel on the front end of the countershaft of the transmission.

Document DE 44 45 024 describes a retarder arranged on the secondary side the on a high-speed shalt of the transmission.

Document DE 196 41 557 A1 describes a retarder operated according to the travelling speed, subsequently secondary retarder, which may however also be arranged on the primary side of the transmission, in particular together with a water pump.

Document EP 1 548 315 B1 describes the arrangement of a hydrodynamic retarder on an auxiliary power takeoff, a so-called “Power taker-off” of the drive motor in a housing supported by the drive motor, whereas the retarder input shaft includes a flange for connecting an additional auxiliary unit.

Although a large number of arrangement possibilities has hence already been suggested for a hydrodynamic retarder in the drive train, there is a persistent need to integrate the retarder into the drive train cost efficiently.

The object of the invention is then to offer a drive train with a hydrodynamic retarder, in which integration and in particular retrofitting of the retarder is permitted in particularly cost efficient manner. To do so, the integration should minimise the need of re-arranging the drive train, for optimal use of the existing construction space and rational usage of existing components for integration of the retarder.

The object of the invention is satisfied with a drive train exhibiting the features of claim 1. Advantageous and particularly appropriate embodiments of the invention are disclosed in the dependent claims.

The invention concerns the integration of a hydrodynamic retarder on an auxiliary power takeoff of the drive motor, however not on the previously utilised primary side of the drive motor away from the transmission, but rather on an auxiliary power takeoff of the drive motor on the transmission side, hence the secondary side of the drive motor. The arrangement hence requires no construction space in the area of the main output shaft of the drive motor or of the transmission input shaft of the transmission connected downstream of the drive motor and the transmission housing can, if required, be used skillfully for receiving individual components of the retarder, in particular of the secondary wheel of the retarder or of the whole retarder. At the same time, auxiliary power takeoffs of the drive motor remain on the primary side thereof, also designated as Power Take-Off, available for receiving other auxiliary units without making it necessary as described initially to provide an additional flange on the retarder input shaft for accommodating respectively for connecting additional auxiliary units. This does not mean that with the present arrangement according to the invention such a connection possibility cannot be offered on the secondary side of the drive motor.

In detail, the drive train according to the invention, in particular a motor vehicle drive train, has a drive motor with a main output shaft and a transmission connected downstream of the drive motor in the drive power connection having a transmission input shaft and a transmission housing. The transmission input shaft is in driving connection with the main output shaft of the drive motor or can be switched into such connection by means of a coupling.

The drive motor is in particular designed as an internal combustion engine, comprising a crankshaft. The crankshaft can form the main output shaft and consequently be connected or connectable to the transmission input shaft.

The transmission is advantageously designed as a variable speed transmission, in particular as an automatic transmission, automated gearbox or manual transmission. Also other transmission designs, for instance continuously variable transmissions or double-clutch transmissions can be contemplated. As a rule, drive wheels of the motor vehicle are driven accordingly by the drive motor via the transmission, usually by interposition of a cardan shaft.

Alternately, the invention can also be used with a stationary drive train in which a unit is driven by the drive motor via the transmission. Also in case of use in a motor vehicle, the transmission can be arranged in the drive power flow between the drive motor and a unit of the motor vehicle which should be driven by means of the drive motor.

A hydrodynamic retarder is provided according to the invention, comprising a driven bladed primary wheel, also called rotor, and a stationary bladed secondary wheel or which is driven in reverse direction of the primary wheel. A counter-rotating retarder is formed when the secondary wheel is driven in reverse direction of the primary wheel. When the secondary wheel is stationary, it is designated as a stator.

The primary wheel and the secondary wheel form together a work space which is filled or can be filled with working medium, in which a circular flow of a working medium is adjusted in braking mode, for hydrodynamic transmission of torque from the primary wheel to the secondary wheel and hence slowing down the primary wheel.

The drive motor includes an auxiliary output shaft, via which the primary wheel of the retarder is driven.

According to the invention, the hydrodynamic retarder is now connected to the auxiliary output shaft of the drive motor on the transmission side.

In an embodiment according to the invention, the primary wheel of the retarder is supported by the auxiliary output shaft of the drive motor. In a particularly advantageous embodiment, the primary wheel of the retarder is mounted overhung on the auxiliary output shaft.

Alternately, the retarder may comprise a retarder input shaft and a retarder housing, whereas the retarder input shaft is mounted in the retarder housing and in particular carries the primary wheel. The retarder input shaft is then connected to the auxiliary output shaft, in particular directly. Alternately, the retarder input shaft is in driving connection via one or several additional interposed shafts and/or gear ratios, in particular by gear wheels.

The retarder housing can be mounted on the engine housing. Additionally or alternately, the retarder housing is mounted on the transmission housing.

If the retarder housing is mounted on the transmission housing, the bearing assembly can be arranged in such a way that the retarder housing is supported mostly exclusively by the transmission housing. Alternately, additional brackets are provided on the engine housing. Conversely, the retarder housing or only the of the of the retarder can be supported to prevent bending on the transmission housing, whereas the secondary wheel, to be more accurate the retarder housing, can be mounted on another component, in particular the engine housing.

If a heat exchanger is associated with the retarder, via which heat is discharged from the working medium of the retarder, in particular oil, so said heat exchanger can be mounted on the retarder housing and/or transmission housing and/or engine housing or be supported by the corresponding components. In terms of heat transfer, a vehicle cooling circuit, in particular with water or another water mixture as a cooling medium, on the heat exchanger on the secondary side, via which cooling medium the drive motor is also cooled. Heat can hence be discharged from the retarder medium into the cooling medium.

According to another embodiment, the retarder is integrated into the vehicle cooling circuit and the cooling medium is simultaneously the working medium of the retarder.

The secondary wheel can advantageously be mounted in the retarder housing in the embodiment with a counterrotating secondary wheel as well as with a stationary secondary wheel.

The invention will be described below using exemplary embodiments and the figures by way of example.

The figures are as follows:

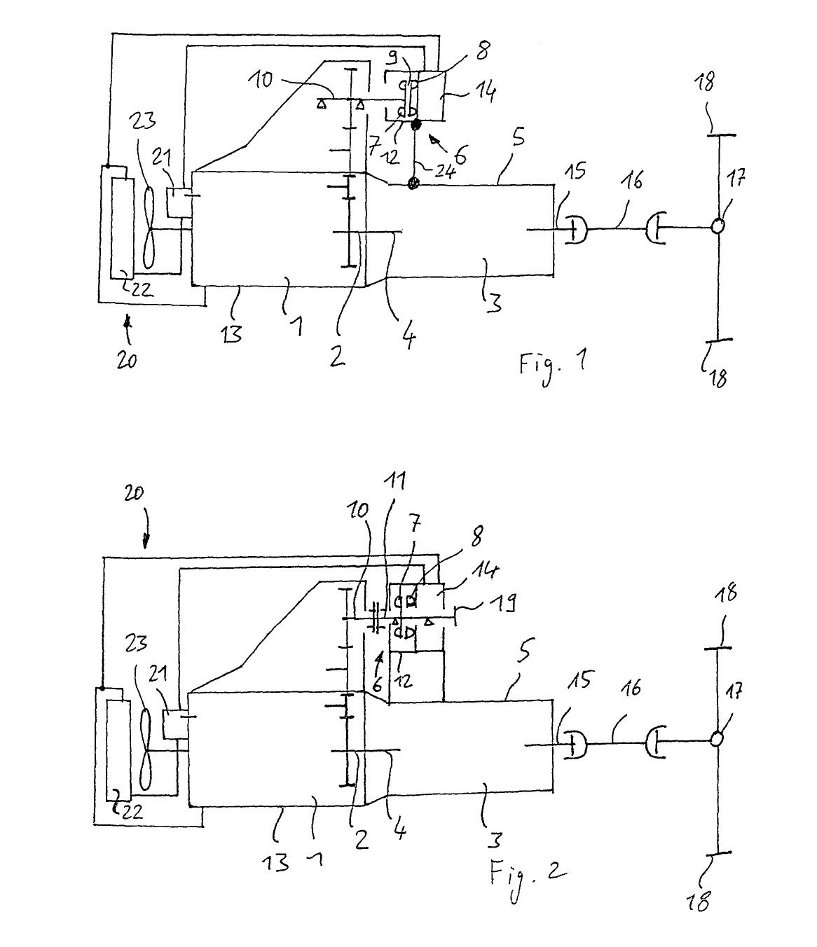

FIG. 1 shows a first embodiment according to the invention with a cantilever mounting of the primary wheel of the retarder on the auxiliary power takeoff of the drive motor;

FIG. 2 shows a mounting of the primary wheel of the retarder in a retarder housing, which is mounted on the transmission housing.

FIGS. 1 and 2 represent a drive motor 1 with a transmission 3 directly connected thereto. The drive motor 1 comprises a main output shaft 2, which is associated with a transmission input shaft 4. A clutch (non represented) can be provided in said drive connection if required, to separate the transmission input shaft 4 from the main output shaft 2 of the drive motor 1.

The drive motor 1 comprises a engine housing 13 and the transmission comprises a transmission housing 5, which surround the corresponding components of said components. Different transmission ratios between the transmission input shaft 4 and a transmission output shaft 15 can be generated in the transmission 3 by connecting corresponding clutches and/or brakes. The transmission output shaft 15 drives the drive wheels 18 of the motor vehicle via a cardan shaft 16 and a differential gear 17.

A hydrodynamic retarder 6, comprising a rotating primary wheel 7 and a stationary secondary wheel 8, which form together a toroidal work space 9, is connected on an auxiliary output shaft 10 of the drive motor 1 on the secondary side thereof The hydrodynamic retarder 6 has a retarder housing 12, which encloses the primary wheel 7 and the secondary wheel 8 and in which the secondary wheel 8 is supported in a torque-proof manner. According to the embodiment variation in FIG. 2, the primary wheel 7 is supported on a retarder input shaft 11 and supported in the retarder housing 12, whereas conversely the primary wheel 7 according to FIG. 1 is mounted overhung on the auxiliary output shaft 10 and only the secondary wheel 8 is carried in the retarder housing 12.

In both exemplary embodiments represented in FIGS. 1 and 2, a heat exchanger 14 is moreover connected to the retarder housing 12 and supported by said housing, which exchanger is included in a vehicle cooling circuit 20, for cooling down the working medium of the retarder 6. The drive motor 1 is also cooled by means of the vehicle cooling circuit 20, in which a cooling medium pump 21 is arranged, driven by the drive motor 1 on an auxiliary drive on the primary side of the drive motor 1, as well as a cooler 22, for discharging heat from the vehicle cooling circuit 20 to the surrounding atmosphere, if required with the aid of the ventilator 23 driven by the vehicle drive motor.

The auxiliary output shaft 10 is mounted inside the engine housing 13 and is in driving connection with the main output shaft 2 via interposed gear wheel stages. In the embodiment according to FIG. 2, the auxiliary output shaft 10 is connected to the retarder input shaft 11 coaxially, for instance using the flange connection represented schematically.

In the embodiment according to FIG. 1, the retarder housing 12 is supported on the transmission housing 5 to prevent any torsion, see the torque support 24 represented by way of example. Alternately, the retarder housing 12 could be supported completely by the transmission housing 5.

Moreover, in the embodiment according to FIG. 1, the retarder housing 12 can be connected detachably or permanently to the engine housing 13.

In the embodiment according to FIG. 2, the retarder housing 12 is supported on the transmission housing 5. A connection of the retarder housing 12 to the engine housing 13 can hence be dispensed with or provided additionally.

1. A drive train in particular of a motor vehicle,
1.1 having a drive motor (1), including a main output shaft (2);
1.2 having a transmission (3) connected downstream of the drive motor (1) in the drive power flow, comprising a transmission input shaft (4) and a transmission housing (5);
1.3 the transmission input shaft (4) is in driving connection with the main output shaft (2) of the drive motor or can be switched into such connection by means of a coupling;
1.4 having a hydrodynamic retarder (6), comprising a driven bladed primary wheel (7) and a stationary bladed secondary wheel (8) or which is driven in reverse direction of the primary wheel (7), whereas both wheels form together a toroidal work space which is filled or can be filled with working medium, for hydrodynamic transmission of torque from the primary wheel (7) to the secondary wheel (8);
1.5 the drive motor (1) includes an auxiliary output shaft (10), via which the primary wheel (7) of the retarder (6) is driven;
characterised in that
1.6 the hydrodynamic retarder (6) is connected to the auxiliary output shaft (10) of the drive motor (1) on the transmission side (3).

2. A drive train according to claim 1, characterised in that at least the secondary wheel (8) of the retarder (6) is mounted on the transmission housing (5).

3. A drive train (1) according to claim 1, characterised in that the primary wheel of the retarder is carried by the auxiliary output shaft and in particular is mounted overhung thereon.

4. A drive train according to claim 1, characterised in that the retarder comprises a retarder input shaft and a retarder housing, the retarder input shaft is mounted in the retarder housing and in particular carries the primary wheel , and the retarder input shaft is connected to the auxiliary output shaft, in particular directly.

5. A drive train according to claim 3, characterised in that the drive motor comprises an engine housing and the retarder housing is mounted on the engine housing and in particular additionally on the transmission housing.

6. A drive train according to claim 4, characterised in that the retarder housing (12) is mounted on the transmission housing (5) and is carried by said transmission housing.

7. A drive train according to claim 1, characterised in that the secondary wheel is supported to prevent bending on the transmission housing.

8. A drive train according to claim 1, characterised in that the retarder comprises a heat exchanger, via which heat is discharged from the working medium, in particular oil, in particular in a vehicle cooling circuit connected to the heat exchanger on the secondary side as regards heat transfer, via which the drive motor is also cooled, and the heat exchanger is mounted on the transmission housing in particular together with the retarder housing.

9. A drive train according to claim 5, characterised in that the secondary wheel is mounted in the retarder housing.

10. A drive train according to claim 2, characterised in that the primary wheel of the retarder is carried by the auxiliary output shaft and in particular is mounted overhung thereon.

11. A drive train according to claim 2, characterised in that the retarder comprises a retarder input shaft and a retarder housing, the retarder input shaft is mounted in the retarder housing and in particular carries the primary wheel, and the retarder input shaft is connected to the auxiliary output shaft, in particular directly.

12. A drive train according to claim 4, characterised in that the drive motor comprises an engine housing and the retarder housing is mounted on the engine housing and in particular additionally on the transmission housing.

13. A drive train according to claim 2, characterised in that the secondary wheel is supported to prevent bending on the transmission housing.

14. A drive train according to claim 3, characterised in that the secondary wheel is supported to prevent bending on the transmission housing.

15. A drive train according to claim 4, characterised in that the secondary wheel is supported to prevent bending on the transmission housing.

16. A drive train according to claim 5, characterised in that the secondary wheel is supported to prevent bending on the transmission housing.

17. A drive train according to claim 6, characterised in that the secondary wheel is supported to prevent bending on the transmission housing.

18. A drive train according to claim 2, characterised in that the retarder comprises a heat exchanger, via which heat is discharged from the working medium, in particular oil, in particular in a vehicle cooling circuit connected to the heat exchanger on the secondary side as regards heat transfer, via which the drive motor is also cooled, and the heat exchanger is mounted on the transmission housing in particular together with the retarder housing.

19. A drive train according to claim 3, characterised in that the retarder comprises a heat exchanger, via which heat is discharged from the working medium, in particular oil, in particular in a vehicle cooling circuit connected to the heat exchanger on the secondary side as regards heat transfer, via which the drive motor is also cooled, and the heat exchanger is mounted on the transmission housing in particular together with the retarder housing.

20. A drive train according to claim 4, characterised in that the retarder comprises a heat exchanger, via which heat is discharged from the working medium, in particular oil, in particular in a vehicle cooling circuit connected to the heat exchanger on the secondary side as regards heat transfer, via which the drive motor is also cooled, and the heat exchanger is mounted on the transmission housing in particular together with the retarder housing.
